(19) United States
(12) Patent Application Publication
(10) Pub. No.: US 2013/0246227 A1
(43) Pub. Date: Sep. 19, 2013

(54) Device and Method for Enhancing Buying Experience

(71) Applicant: O2MICRO, INC., Santa Clara, CA (US)

(72) Inventors: Sterling Shyundii Du, Shanghai (CN); Jingjing Zuo, Beijing (CN); Chengxia He, Chengdu (CN); Qi Zhu, Chengdu (CN)

(73) Assignee: O2MICRO, INC., Santa Clara, CA (US)

(21) Appl. No.: 13/782,204

(22) Filed: Mar. 1, 2013

(30) Foreign Application Priority Data
Mar. 15, 2012 (CN) 201210068687.0

(51) Int. Cl. G06Q 30/06

(52) U.S. Cl. CPC G06Q 30/0643
USPC 705/27.2

(57) ABSTRACT

A method for enhancing buying experience. The method for enhancing buying experience includes acquiring information regarding clothes and a body size of a user; generating a model of the clothes based on the information regarding clothes and the body size of the user; acquiring a current posture of the user; modifying the model of the clothes according to the current posture of the user to generate a modified model of the clothes; and combining a real-time photo of the user with the modified model of the clothes to compose a real-time image.

### RELATED APPLICATIONS

This application claims priority to Chinese Patent Application No. 201210068587.0, filed on Mar. 15, 2012 with the State Intellectual Property Office of the People's Republic of China, incorporated by reference in its entirety herein.

### FIELD OF THE INVENTION

The present invention relates generally to a field of virtual reality, specifically to virtual reality applied to garment industry.

### BACKGROUND

Trying out a piece of clothing before a purchase has been a ritual for a buyer almost since the retail industry was established. With the advent of the Internet and Internet commerce, the retail industry has been moving into the virtual world enabled by the Internet. However, it is impossible to try a piece of garment when the purchase is conducted through the Internet.

With the development of technology, virtual fitting technology has been developed and provides some relief to this problem. Virtual fitting technology allows virtual models to be created to try on different clothes for users. However, because the body size of a buyer is usually different from the body size of the virtual model, it is still difficult for the buyer to visualize whether these clothes are suitable for him/her. Moreover, the posture of the virtual model does not change according to the postures of the buyer to simulate a more realistic fitting process.

Therefore, there is a need for a better way for a buyer to visualize how a piece of garment fits on him or her and it is to this need that the present invention is primarily directed to.

### SUMMARY

The embodiments described herein relate to methods, systems, and programming for enhancing buying experience.

In an embodiment, a method for enhancing buying experience is disclosed. The method includes acquiring information regarding clothes and a body size of a user; generating a model of the clothes based on the information regarding clothes and the body size of the user; acquiring a current posture of the user; modifying the model of the clothes according to the current posture of the user to generate a modified model of the clothes; and combining a real-time photo of the user with the modified model of the clothes to compose a real-time image.

In another embodiment, a device for enhancing buying experience is disclosed. The device includes an information acquisition module, a model generation module, a posture acquisition module, a modify module and a synthesis module. The information acquisition module is configured to acquire information regarding clothes and a body size of a user. The model generation module is configured to generate a model of the clothes based on the information regarding clothes and the body size of the user. The posture acquisition module is configured to acquire a current posture of the user. The modify module is configured to modify the model of the clothes according to the current posture of the user to generate a modified model of the clothes. The synthesis module is configured to combine a real-time photo of the user with the modified model of the clothes to compose a real-time image.

Additional advantages and novel features will be set forth in part in the description which follows, and in part will become apparent to those skilled in the art upon examination of the following and the accompanying drawings or may be learned by production or operation of the disclosed embodiments. The advantages of the present embodiments may be realized and attained by practice or use of various aspects of the methodologies, instrumentalities and combinations set forth in the detailed description set forth below.

### BRIEF DESCRIPTION OF THE DRAWINGS

Features and advantages of embodiments of the claimed subject matter will become apparent as the following detailed description proceeds, and upon reference to the drawings, wherein like numerals depict like parts. These exemplary embodiments are described in detail with reference to the drawings. These embodiments are non-limiting exemplary embodiments, in which like reference numerals represent similar structures throughout the several views of the drawings.

FIG. 1 illustrates a block diagram of device for enhancing buying experience, in accordance with an embodiment of the present teaching;

FIG. 2 illustrates a block diagram of an device for enhancing buying experience, in accordance with another embodiment of the present teaching;

FIG. 3 illustrates a block diagram of a device for enhancing buying experience, in accordance with another embodiment of the present teaching;

FIG. 4 illustrates a flowchart of a method for enhancing buying experience, in accordance with an embodiment of the present teaching;

FIG. 5A-FIG. 5B illustrate a flowchart of a method for enhancing buying experience, in accordance with another embodiment of the present teaching; and

FIG. 6 illustrates a block diagram of a computer, in accordance with an embodiment of the present teaching.

### DETAILED DESCRIPTION

Reference will now be made in detail to the embodiments of the present teaching. While the present teaching will be described in conjunction with these embodiments, it will be understood that they are not intended to limit the present teaching to these embodiments. On the contrary, the present teaching is intended to cover alternatives, modifications and equivalents, which may be included within the spirit and scope of the present teaching as defined by the appended claims.

Furthermore, in the following detailed description of the present teaching, numerous specific details are set forth in order to provide a thorough understanding of the present teaching. However, it will be recognized by one of ordinary skill in the art that the present teaching may be practiced without these specific details. In other instances, well known methods, procedures, components, and circuits have not been described in detail as not to unnecessarily obscure aspects of the present teaching.

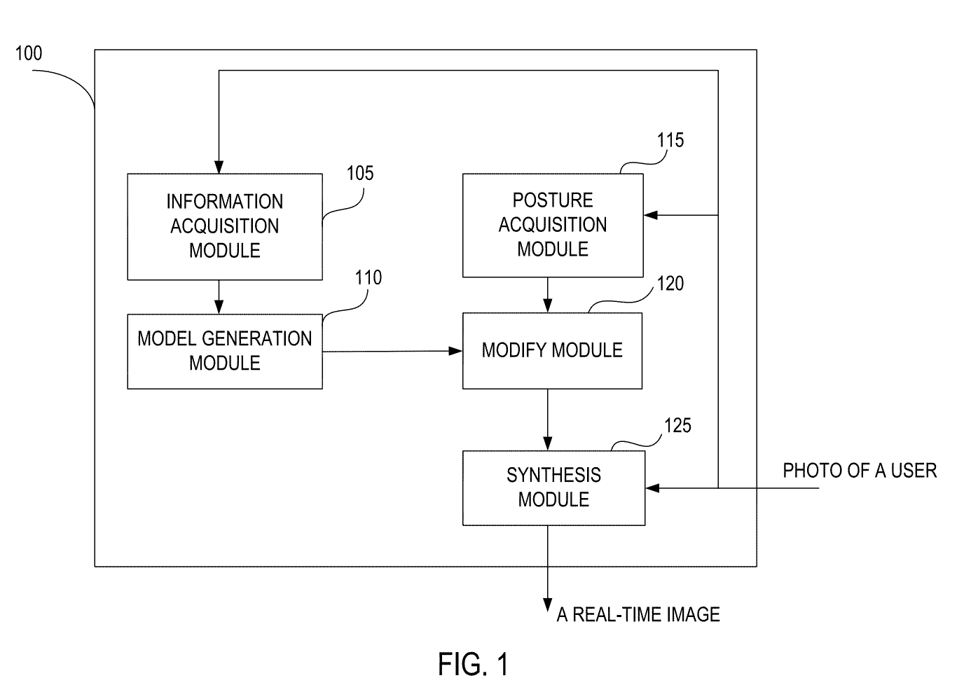

FIG. 1 illustrates a block diagram of a device 100 for enhancing buying experience, in accordance with an embodiment of the present teaching. As shown in FIG. 1, the device 100 includes an information acquisition module 105, a model generation module 110, a posture acquisition module 115, a modify module 120 and a synthesis module 125.

The information acquisition module 105 is configured to acquire information regarding clothes and a body size of a user. The information regarding clothes includes clothing style and clothing size. The model generation module 110 is configured to generate a model of the clothes based on the information regarding clothes and the body size of the user. The posture acquisition module 115 is configured to acquire a current posture of the user. The modify module 120 is configured to modify the model of the clothes according to the current posture of the user to generate a modified model of the clothes. The synthesis module 125 is configured to combine a real-time photo of the user with the modified model of the clothes to compose a real-time image which shows the effect of fitting. The posture acquisition module 115 can acquire the current posture of the user based on the real-time photo of the user.

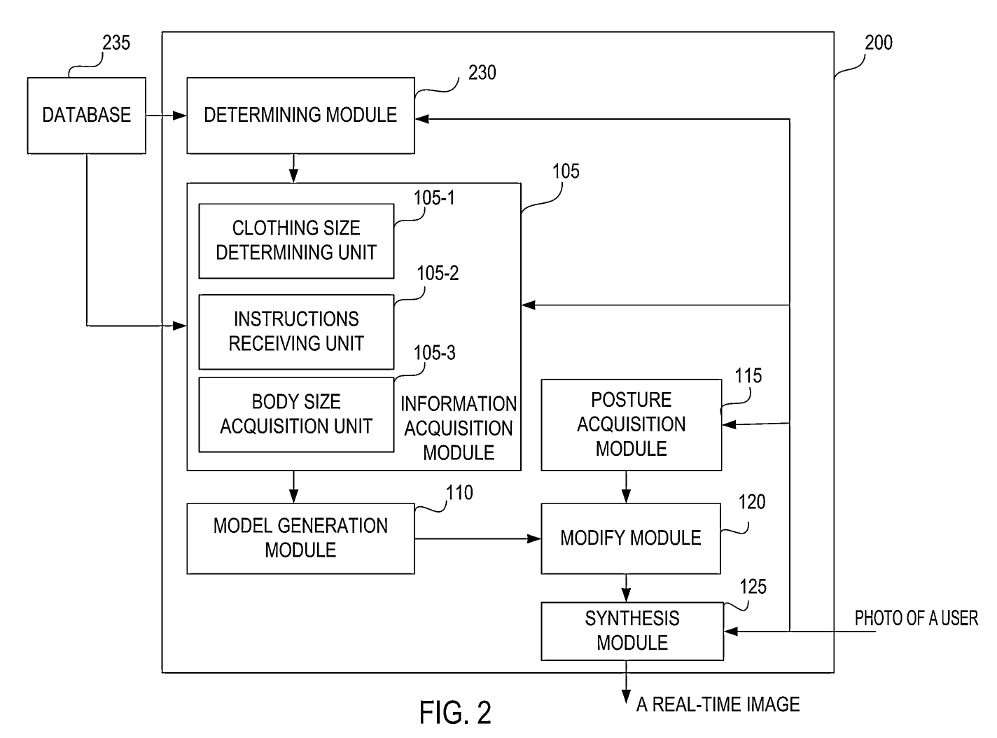

FIG. 2 illustrates a block diagram of a device 200 for enhancing buying experience, in accordance with another embodiment of the present teaching. Elements labeled the same in FIG. 1 have similar functions. Comparing with the device 100 in FIG. 1, the device 200 further includes a determining module 230 and a database 235. The determining module 230 is configured to check whether a current user is a registered user. For a registered user, user data is previously stored. In other words, the information of a registered user is known. The user data includes a body size, photos and fingerprints of the user. More specifically, the body size of the user includes a body height, a chest girth, a waist girth, a hip girth, a shoulder width, an arm length, a leg length and a head circumference. Optionally, the user data also includes preferences of the user such as color, style, accessories, etc.

In operation, the determining module 230 checks whether a current user is a registered user by facial recognition. The real-time photo of the user and pre-stored data (e.g., pre-stored photos) in an interior database or an exterior database (e.g., the database 235 as shown in FIG. 2) may be used for facial recognition. Alternatively, the determining module 230 checks whether a current user is a registered user by fingerprint recognition. The fingerprints of registered users are pre-stored in an interior database or an exterior database (e.g., the database 235).

As shown in FIG. 2, the information acquisition module 105 includes a clothing size determining unit 105-1, an instruction receiving unit 105-2 and a body size acquisition unit 105-3. If the determining unit 230 determines a current user is a registered user, the body size acquisition unit 105-3 accesses the database 235 to retrieve a body size of the user. If the determining unit 230 determines the current user is not a registered user, the body size acquisition unit 105-3 acquires a body size based on the real-time photo of the user. The clothing size determining unit 105-1 determines clothing size based on the body size of the user acquired by the body size acquisition unit 105-3.

The instruction receiving unit 105-2 detects whether there are instructions from the user to change clothing style or clothing size. If an instruction is received, the model generation module 110 re-generates a model of the clothes based on the body size of the user and newly-changed clothing size or clothing style.

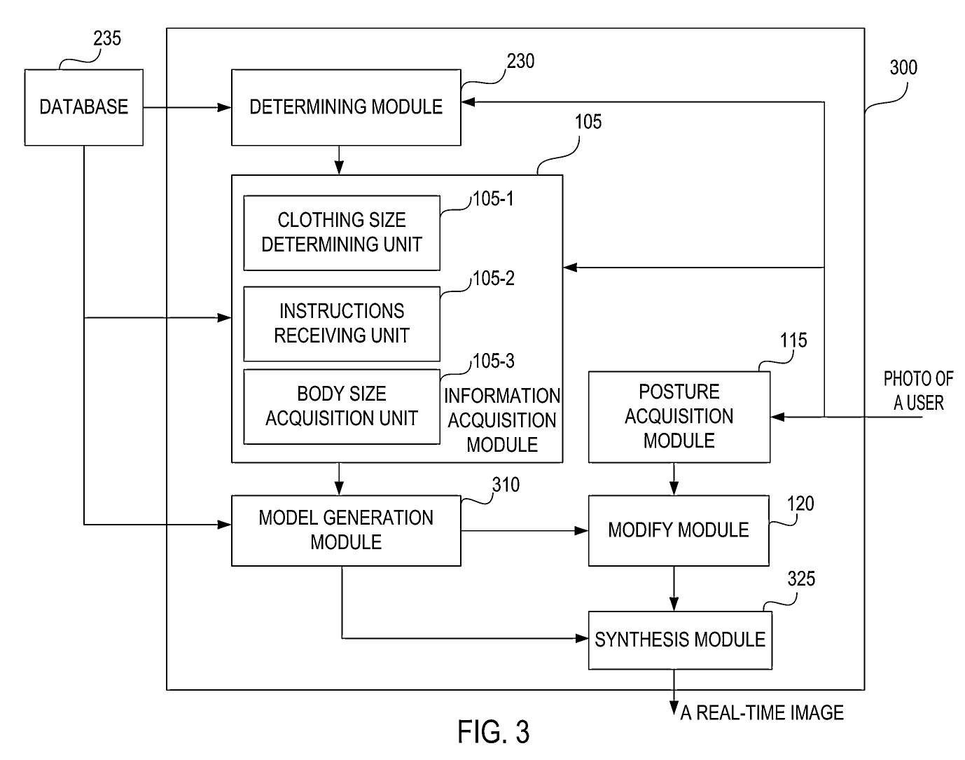

FIG. 3 illustrates a block diagram of a device 300 for enhancing buying experience, in accordance with another embodiment of the present teaching. Elements labeled the same in FIG. 2 have similar functions. Comparing with the device 200 in FIG. 2, instead of receiving a real-time photo of the user from an exterior device, a synthesis module 325 receives a model of a user from a model generation module 310. More specifically, the model generation module 310 can generate a model of a user based on the body size of the user acquired by the body size acquisition unit 105-3.

In operation, the determining module 230 checks whether a current user is a registered user. In one embodiment, the determining module 230 checks whether a current user is a registered user by checking a user name and a password typed by the user. In another embodiment, the determining module 230 checks whether a current user is a registered user by fingerprint recognition or facial recognition.

If the determining unit 230 determines that the current user is a registered user, the model generation module 310 accesses the database 235 to retrieve a previously-stored model of the user. If the determining unit 230 determines that the current user is not a registered user, the model generation module 310 sends out a message to require the user to type in the body size. Then the model generation module 310 generates model of the user based on the body size of the user.

The synthesis module 325 receives the model of the user from the model generation module 310 and combines the model of the user with a model of the clothes to compose a real-time image which shows the effect of fitting.

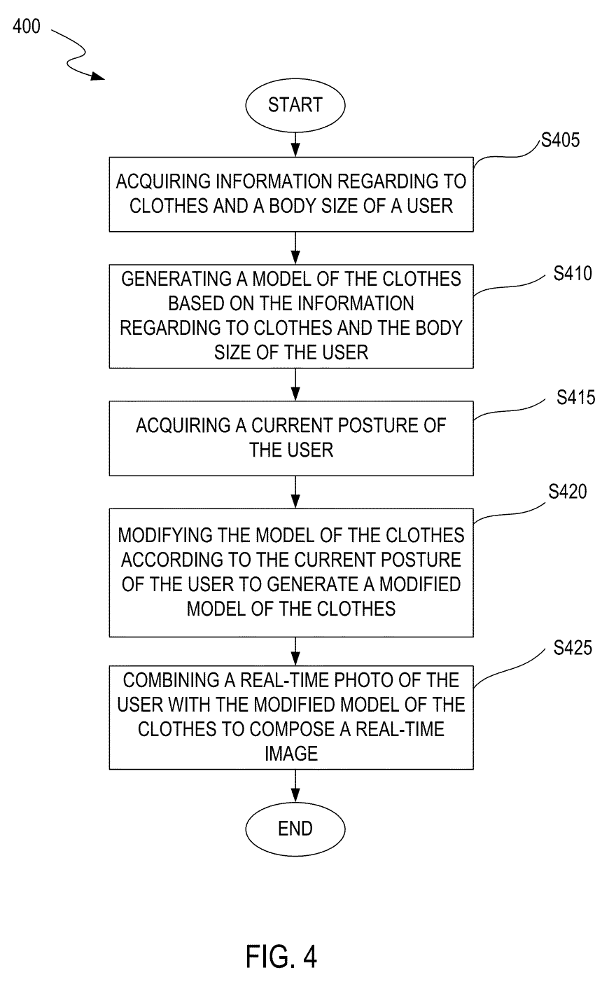

FIG. 4 illustrates a flowchart of a method 400 for enhancing buying experience, in accordance with an embodiment of the present teaching. FIG. 4 is described in combination with FIG. 1 and FIG. 2. An information acquisition module 105 acquires information regarding clothes and a body size of a user, step S405. The information regarding clothes includes clothing style and clothing size. A model generation module 110 generates a model of the clothes based on the information regarding clothes and the body size of the user, step S410. A posture acquisition module 115 acquires a current posture of the user, step S415. A modify module 120 modifies the model of the clothes according to the current posture of the user to generate a modified model of the clothes, step S420. A synthesis module 125 combines a real-time photo of the user with the modified model of the clothes to compose a real-time image which shows the effect of fitting, step S425.

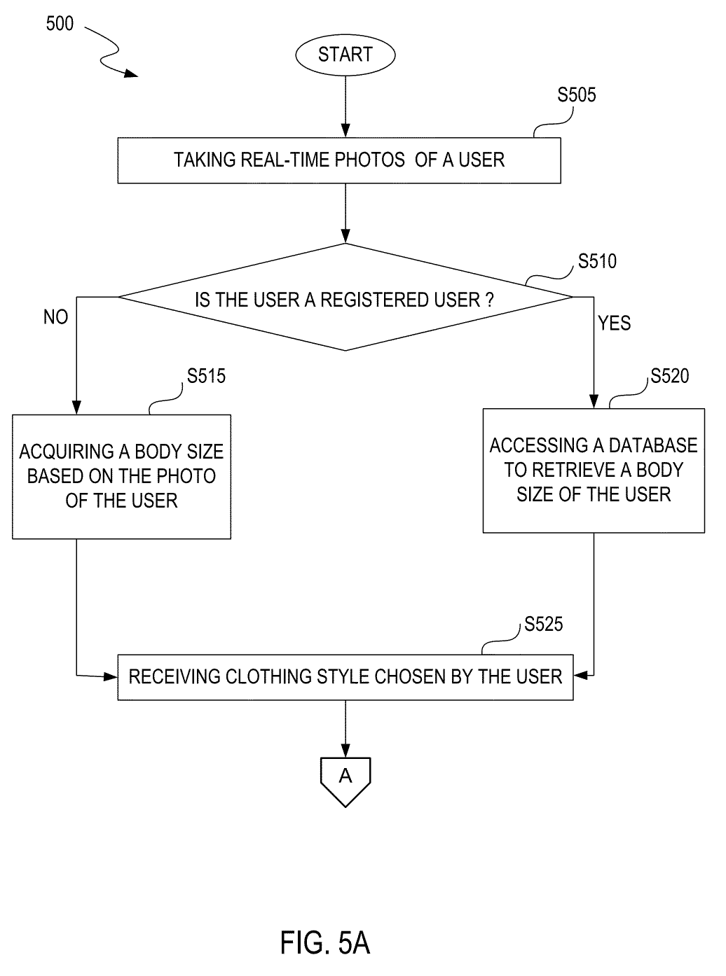

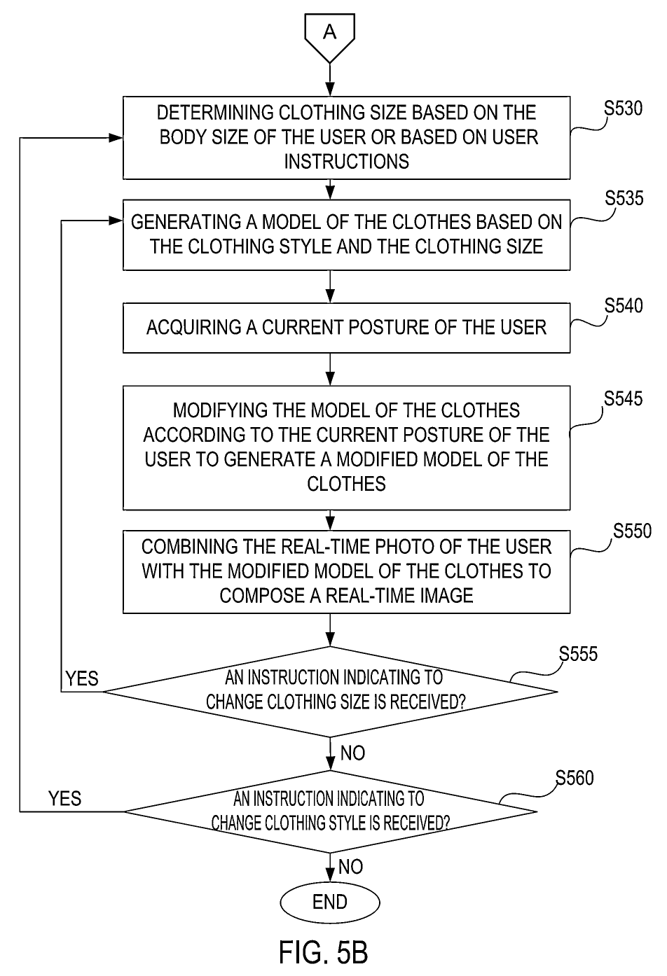

FIG. 5A-FIG. 5B illustrate a flowchart of a method 500 for enhancing buying experience, in accordance with an embodiment of the present teaching. FIG. 5A-FIG.5B are described in combination with FIG. 1 and FIG. 2. A camera takes real-time photos of the user, step S505. The real-time photos of the user may be facial photos or body photos. The determining unit 230 checks whether a current user is a registered user, step S510. For a registered user, user data is previously stored, e.g., in a database 235. In other words, the information of a registered user is known. The user data includes a body size, fingerprints, and photos of the user. More specifically, the body size of the user includes a body height, a chest girth, a waist girth, a hip girth, a shoulder width, an arm length, a leg length and a head circumference. Optionally, the user data also includes preferences of the user. The determining unit 230 can check whether a current user is a registered user by facial recognition. The real-time photos of the current user and pre-stored user data (e.g., pre-stored photos) may be used for the facial recognition. Alternatively, the determining unit 230 can check whether a current user is a registered user by comparing the fingerprints of the current user with pre-stored user data (e.g., pre-stored fingerprints). If the user is not a registered user, the process goes to step S515. Otherwise, if the user is a registered user, the process goes to step S520.

If the user is not a registered user, a body size acquisition unit 105-3 acquires a body size based on the photos of the user, step S515. If the user is a registered user, the body size acquisition unit 105-3 accesses the database 235 to retrieve the body size of the user, step S520. Optionally, for a registered user, the body size acquisition unit 105-3 also retrieves preferences of the user from the database 235, e.g., the user prefers tight clothes. An information acquisition module 105 receives the clothing style of clothes chosen by the user, step S525. More specifically, the information acquisition module 105 receives the clothing style from user through selections made via input devices such as touch screens, mouse, keyboards or barcode readers. The clothing style includes, but not limited to, coat, trouser, one-piece dress, bust skirt and hat.

A clothing size determining unit 105-1 in the information acquisition module 105 determines clothing size based on the body size of the user acquired by the body size acquisition unit 105-3 if the user is not a registered user, or based on the previously stored user data if the user is a registered user, step S530. Instead of determining clothing size based on the body size of the user, the clothing size determining unit 105-1 can also receive clothing size directly from the user. Optionally, for a registered user, the clothing size determining unit 105-1 determines clothing size with further consideration of preferences of the user, such as color, style, accessories, etc.

A model generation module 110 generates a model of the clothes based on the information regarding clothes, step S535. The information regarding clothes includes clothing style obtained in step S525 and clothing size obtained in step S530. A posture acquisition module 115 acquires a current posture of the user based on the real-time photo of the user, step S540. The posture of the user includes, but not limited to, standing or bending. A modify module 120 modifies the model of the clothes in real time according to the posture of the user, step S545. More specifically, if the user stands with his face toward the camera, the modify module 120 turns the model of the clothes to display the front side of the clothes. If the user stands with his back facing the camera, the modify module 120 turns the model of the clothes to display the back side of the clothes. If the user stands with hands on the hips, the modify module 120 modifies the sleeves of the model of the clothes to accommodate the posture.

A synthesis module 125 combines the real-time photo of the user with the modified model of the clothes to compose a real-time image to display on a screen which shows the effect of fitting, step S550. An instruction receiving unit 105-2 checks whether there are instructions from the user that indicate changes in the clothing size, step S555. If an instruction to change clothing size is received by the instruction receiving unit 105-2, the process goes back to step S535. Otherwise, if there is no instruction to change clothing size received, the process goes to step S560.

The instruction receiving unit 105-2 checks whether there are instructions from the user that indicate changes in the clothing style, step S560. If an instruction to change clothing style is received by the instruction receiving unit 105-2, the process goes to step S530. Otherwise, if there is no instruction to change clothing style received, the process ends.

The model generation module 110 may also generate a model of the user based on the body size of the user. Then the synthesis module 125 can combine the model of the user with the modified model of the clothes to compose a real-time image which shows the effect of fitting.

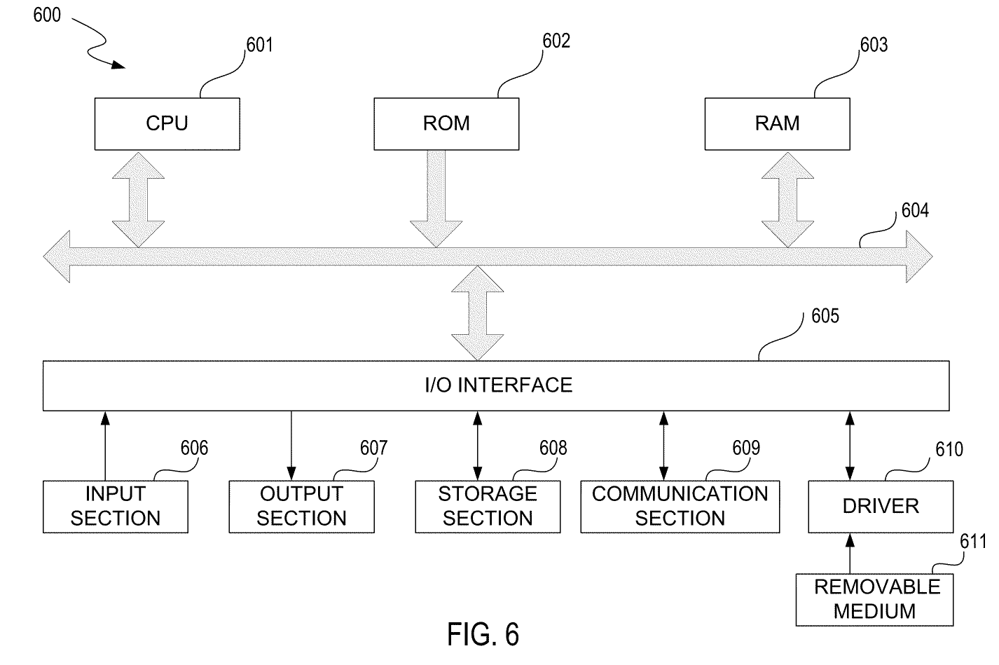

FIG. 6 illustrates a general computer architecture on which the embodiments described herein can be implemented and has a functional block diagram illustration of a computer hardware platform which includes user interface elements. The computer may be a general purpose computer or a special purpose computer. Although only one such computer is shown, for convenience, the computer functions relating to development and hosting of applications may be implemented in a distributed fashion on a number of similar platforms, to distribute the processing load.

The computer 600, for example, includes a central processing unit (CPU) 601, in form of one or more processors, for executing program instructions. The exemplary computer platform includes a bus 604, program storage and data storage of different forms, e.g., read-only memory (ROM) 602 or random access memory (RAM) 603, for various data files to be processed and/or communicated by the computer 600, as well as possibly program instructions to be executed by the CPU 601. The data files and program instructions can be loaded to random access memory (RAM) 603 from a storage selection 608. The CPU 601, the ROM 602 and the RAM 603 are coupled to a bus 604. The computer 600 also includes an I/O interface 605, supporting, input/output flows between the computer and other components. The I/O interface 605 is also coupled to the bus 604.

A input section 606, a output section 607, a storage section 608, a communication section 609 are all coupled to the I/O interface 605. The input section 606 includes keyboards and mouse. The output section 607 includes speakers and displays such as Cathode Ray Tube (CRT) Displays or Liquid Crystal Displays (LCD). The storage section 608 includes hard disks. The communication section 609 includes modems or network interface cards such as Local Area Network (LAN) cards. The communication section 609 is coupled to network such as the internet to communicate. Such communications, for example, may enable loading of the software from one computer or processor into another, for example, from a server or host computer into the hardware platform(s) of a computing environment or other system implementing a computing environment or similar functionalities in connection with generating explanations based on user inquiries. According to practical needs, a driver 610 can be coupled to the I/O interface 605. The driver 610 can read program instructions from removable media 611 and stores the program instructions in the storage section 608. The CPU 601 can executes program instructions in the ROM 602, or program instructions loaded from the storage section 608 to the RAM 603 to perform varies functions.

Hence, aspects of the methods of developing, deploying, and hosting applications that are interoperable across a plurality of device platforms, as outlined above, may be embodied in programming. Program aspects of the technology may be thought of as “products” or “articles of manufacture” typically in the form of executable code and/or associated data that is carried on or embodied in a type of machine readable medium. The removable media 611 include any or all of the memory or other storage for the computers, processors or the like, or associated schedules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a server or host computer into the hardware platform(s) of a computing environment or other system implementing a computing environment or similar functionalities in connection with generating explanations based on user inquiries. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media includes dynamic memory, such as a main memory of such a computer platform. Tangible transmission media includes coaxial cables, copper wire, and fiber optics, including wires that form a bus within a computer system. Carrier-wave transmission media can take the form of electric or electromagnetic signals, or acoustic or light waves such as those generated during radio frequency (RF) and infrared (IR) data communications. Common forms of dissemble media 611 therefore include for example: a floppy disk, a flexible disk, hard disk, magnetic take, any other magnetic medium, a CD-ROM, DVD or DVD-ROM, any other optical media, punch card paper tapes, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the embodiments of the present teaching are amenable to a variety of modifications an/or enhancements. For example, although the implementation of various components described above may be embodied in a hardware device, it can also be implemented as a software only solution —e.g., an installation on an existing server. In addition, the dynamic relation/event detector and its components as disclosed herein can be implemented as firmware, a firmware/software combination, a firmware/hardware combination, or a hardware/firmware/software combination.

While the foregoing description and drawings represent embodiments of the present teaching, it will be understood that various additions, modifications and substitutions may be made therein without departing from the spirit and scope of the principles of the present teaching as defined in the accompanying claims. One skilled in the art will appreciate that the teaching may be used with many modifications of form, structure, arrangement, proportions, materials, elements, and components and otherwise, used in the practice of the teaching, which are particularly adapted to specific environments and operative requirements without departing from the principles of the present teaching. The presently disclosed embodiments are therefore to be considered in all respects as illustrative and not restrictive, the scope of the teaching being indicated by the appended claims and their legal equivalents, and not limited to the foregoing description.

We claim:

1. A method, for enhancing clothing buying experience, comprising the steps of:
acquiring information regarding clothes and a body size of a user;
generating a model of the clothes based on the information regarding clothes and the body size of the user;
acquiring a current posture of the user;
modifying the model of the clothes according to the current posture of the user to generate a modified model of the clothes; and
combining a real-time photo of the user with the modified model of the clothes to compose a real-time image.

2. The method of claim 1, wherein the step of acquiring a posture of the user further comprises the step of:
acquiring the current posture of the user based on the real-time photo of the user.

3. The method of claim 1, further comprising the step of:
checking whether the user is a registered user.

4. The method of claim 3, wherein the step of checking whether the user is a registered user further comprises the step of:
checking whether the user is a registered user based on the real-time photo of the user.

5. The method of claim 3, wherein the step of acquiring information regarding clothes and a body size of a user further comprises the step of:
accessing a database to retrieve the body size of the user if the user is a registered user.

6. The method of claim 3, wherein the step of acquiring information regarding clothes and a body size of a user further comprises the step of:
acquiring the body size of the user based on the real-time photo of the user if the user is not a registered user.

7. The method of claim 1, wherein the information regarding clothes comprises clothing style and clothing size.

8. The method of claim 7, further comprising the step of:
determining the clothing size based on the body size of the user.

9. The method of claim 7, further comprising the steps of:
receiving instructions which indicate to change the clothing style or the clothing size; and
re-generating a model of the clothing based on the body size of the user and newly-changed clothing size or clothing style.

10. The method of claim 1, further comprising the steps of:
generating a model of the user based on the body size of the user; and
combining the model of the user with the modified model of the clothes to compose a real-time image.

11. A device for enhancing buying experience, the device comprising:
an information acquisition module for acquiring information regarding clothes and a body size of a user;
a model generation module for generating a model of the clothes based on the information regarding clothes and the body size of the user;
a posture acquisition module for acquiring a current posture of the user;
a modify module for modifying the model of the clothes according to the current posture of the user to generate a modified model of the clothes; and
a synthesis module for combining a real-time photo of the user with the modified model of the clothes to compose a real-time image to display on a screen.

12. The device of claim 11, wherein the posture acquisition module is further configured to acquire the current posture of the user based on the real-time photo of the user.

13. The device of claim 11, wherein the device further comprises:
a determining module for checking whether the user is a registered user.

14. The device of claim 13, wherein the determining module is configured to:
check whether the user is a registered user based on the real-time photo of the user.

15. The device of claim 13, wherein the information acquisition module comprises:
a body size acquisition unit for accessing a database to retrieve the body size of the user if the user is a registered user, and for acquiring the body size of the user based on the real-time photo of the user if the user is not a registered user.

16. The device of claim 11, wherein the information regarding clothes comprises clothing style and clothing size.

17. The device of claim 16, wherein the information acquisition module comprises:
a clothing size determining unit for determining the clothing size based on the body size of the user.

18. The device of claim 16, wherein the information acquisition module comprises:
an instruction receiving unit for receiving instructions which indicate to change the clothing style or the clothing size, wherein the modify module re-generates a model of the clothes based on the body size of the user and newly-changed clothing size or clothing style.

19. The device of claim 11, wherein the model generation module is further configured to generate a model of the user based on the body size of the user, and wherein the synthesis module is further configured to combine the model of the user with the modified model of the clothes to compose a real-time image.
